(19) United States
(12) Patent Application Publication
(10) Pub. No.: US 2026/0192265 A1
(43) Pub. Date: Jul. 9, 2026

(54) COMBINED IMPELLER STIRRING DEVICE AND APPLICATION THEREOF

(71) Applicant: Institute of Process Engineering, Chinese Academy of Sciences, Beijing (CN)

(72) Inventors: Chao YANG, Beijing (CN); Xiaoxia DUAN, Beijing (CN); Xin FENG, Beijing (CN); Jie CHEN, Beijing (CN); Weipeng ZHANG, Beijing (CN)

(73) Assignee: Institute of Process Engineering, Chinese Academy of Sciences, Beijing (CN)

(21) Appl. No.: 19/414,909

(22) Filed: Dec. 10, 2025

(30) Foreign Application Priority Data
Jan. 6, 2025 (CN) 202510012913.3

(51) Int. Cl. B01F 27/192; B01F 27/1124; B01F 27/113; B01F 27/1145

(52) U.S. Cl. CPC B01F 27/192; B01F 27/1124; B01F 27/1134; B01F 27/1145

(57) ABSTRACT

A combined impeller stirring device includes a stirred tank, a stirring shaft disposed within the stirred tank, and at least one mixing impeller unit disposed on the stirring shaft. The mixing impeller unit includes a first nested mixing impeller and a second nested mixing impeller. The first nested mixing impeller includes two helical blades and two fixed shafts. The two fixed shafts are arranged in a staggered manner and separately fixedly connected to the stirring shaft. Two ends of a helical blade are connected to the two fixed shafts, respectively such that the two helical blades are arranged in rotational symmetry. The second nested mixing impeller is located between the two fixed shafts and fixedly connected to the stirring shaft.

### CROSS-REFERENCE TO RELATED APPLICATION(S)

This application claims priority to Chinese Patent Application No. 202510012913.3 filed Jan. 6, 2025, the disclosure of which is incorporated herein by reference in its entirety.

### TECHNICAL FIELD

The present disclosure belongs to mixing equipment in the field of petrochemical technology, specifically relating to a combined impeller stirring device and an application thereof.

### BACKGROUND

The preparation process of fluidized catalytic cracking (FCC) catalysts typically involves mixing molecular sieve stock solution, kaolin, pseudo-boehmite, and acid in a specific proportion to form a slurry with a solid content of approximately 20-40%, commonly referred to as the gelation process. Higher solid content in the slurry not only increases production efficiency but also reduces energy consumption during subsequent spray drying, improves the sphericity of the product, and reduces the formation of fine powder. During the acidification and gelation process of high-solid-content FCC catalyst slurry, the material exhibits strong shear-thinning characteristics, with apparent viscosity significantly decreasing as the fluid shear rate increases.

The impeller is a core component of a stirring device and determines the flow and mixing efficiency of the liquid within the device. The blades of the impeller drive fluid flow, and the resulting fluid velocity distribution inevitably affects the apparent viscosity of the strongly shear-thinning catalyst slurry within the stirring device. If the impeller is poorly designed, stagnation zones with zero velocity gradients are likely to form within the stirring device. In these stagnation zones where the impeller has no effect, the slurry viscosity becomes extremely high, and the slurry in these zones is nearly stagnant. This leads to severe non-uniform mixing of materials during the acidification process in the stirring device, which adversely affects product quality and acidification time.

To enhance the mixing of shear-thinning non-Newtonian and high-viscosity fluids, CN108339445B discloses a combined impeller stirring device, and CN207970760U discloses another combined impeller stirring device. The stirring devices disclosed in these patents include a combination of multiple radial flow impellers, a combination of multiple axial flow impellers, or a hybrid combination of axial and radial flow impellers. While such combined impeller stirring devices can improve the mixing effect of high-viscosity and variable-viscosity fluids in the reactor to some extent, the limited sweep range of each blade during rotation results in rapid attenuation of the velocity gradient generated by the blade-driven fluid in mixing high-solid-content and strongly shear-thinning slurries. This causes the energy provided by the impeller to dissipate quickly, leading to poor cyclic mixing of the fluid between impellers. Additionally, when high-viscosity and variable-viscosity fluids are mixed, impellers such as double ribbon impellers, inner-outer ribbon impellers, anchor impellers, or frame impellers are commonly used. Although these impellers can enhance mixing performance within the reactor to some extent, their large diameters, which are nearly equal to the diameter of the reactor of the stirring device, result in high power consumption.

Therefore, improving the mixing efficiency of high-solid-content slurry, reducing mixing energy consumption, and shortening mixing time are urgent issues to be addressed.

### SUMMARY

The present disclosure provides a combined impeller stirring device and an application thereof. By employing a combination of two types of mixing impellers, the device increases the shear edge length of the impellers, increases the shear rate, and reduces the apparent viscosity of high-solid-content and strongly shear-thinning slurries. Moreover, the device shortens the macroscopic mixing time and acidification time of the slurry within the stirring device, reduces power consumption, and effectively improves mixing efficiency.

The present disclosure adopts the technical solutions described below.

In a first aspect, the present disclosure provides a combined impeller stirring device. The device includes a stirred tank, a stirring shaft disposed within the stirred tank, and at least one mixing impeller unit disposed on the stirring shaft. Each mixing impeller unit includes a first nested mixing impeller and a second nested mixing impeller. The first nested mixing impeller includes two helical blades and two fixed shafts. The two fixed shafts are arranged in a staggered manner and are fixedly connected to the stirring shaft. Two ends of each helical blade are respectively connected to the two fixed shafts such that the two helical blades are arranged in rotational symmetry. The second nested mixing impeller is located between the two fixed shafts and is fixedly connected to the stirring shaft.

In the present disclosure, through the synergistic cooperation of the first nested mixing impeller and the second nested mixing impeller, the shear force during the mixing process of slurry is significantly increased, and the apparent viscosity of high-solid-content and strongly shear-thinning slurry is effectively reduced. This ensures that every region within the stirred tank is subjected to the driving force of the impellers and avoids stagnation zones during mixing, thereby effectively improving the mixing effect of materials and reducing mixing time.

In some embodiments, multiple baffles are uniformly distributed on the inner wall of the stirred tank.

In the present disclosure, multiple baffles are arranged at equal intervals on the inner wall of the stirred tank so that the shear force at the edge of the stirred tank can be further increased, and the flow velocity of the fluid at the edge of the stirred tank can be increased, thereby further improving the mixing effect.

The baffles are arranged parallel to the stirring shaft.

Multiple baffles are arranged at equal intervals in the circumferential direction of the stirred tank.

In the present disclosure, the baffles are arranged parallel to the stirring shaft so that the shear force on the slurry during mixing can be increased, thereby further improving mixing efficiency.

In some embodiments, the number of mixing impeller units is at least two, such as 2, 3, 4, 5, or 6, but is not limited to the listed values; other unlisted values within this range are also applicable.

At least two mixing impeller units are arranged at intervals in the axial direction of the stirring shaft.

In the present disclosure, the number of mixing impeller units may be adjusted based on actual needs. Using at least two mixing impeller units can further increase the mixing efficiency of the slurry throughout the stirred tank.

Two adjacent mixing impeller units are staggered by 90°.

The height of a mixing impeller unit is 0.25 to 0.80 times the inner diameter of the stirred tank, for example, 0.25, 0.30, 0.40, 0.50, 0.60, 0.70, or 0.80 times. However, the multiple is not limited to the listed values; other unlisted values within this range are also applicable.

In the present disclosure, the height of the mixing impeller unit is controlled to be 0.25 to 0.80 times the inner diameter of the stirred tank so that the mixing effect of the slurry can be further improved, and the mixing time of the slurry can be reduced.

The spacing between two adjacent mixing impeller units is 1.00 to 1.25 times the height of the mixing impeller unit, for example, 1.00, 1.10, 1.12, 1.14, 1.16, 1.18, 1.20, 1.22, or 1.25 times. However, the multiple is not limited to the listed values; other unlisted values within this range are also applicable.

In the present disclosure, the spacing between two mixing impeller units is controlled to be 1.00 to 1.25 times the height of the mixing impeller unit so that the mixing efficiency of the slurry in the stirred tank can be further improved.

In some embodiments, the leading surface of a helical blade is provided with multiple first protrusions.

In the present disclosure, the leading surface of the helical blade is provided with multiple first protrusions so that the shear edge length of the impeller can be further increased, and the shear force on the slurry during mixing can be increased, thereby improving the mixing efficiency.

The multiple first protrusions are arranged at equal intervals in the length direction of the helical blade.

The shape of the first protrusions includes a triangular prism.

The height of a first protrusion is 0.005 to 0.025 times the inner diameter of the stirred tank, for example, 0.005, 0.010, 0.015, 0.020, or 0.025 times. However, the multiple is not limited to the listed values; other unlisted values within this range are also applicable.

The width of the first protrusion is 0.005 to 0.025 times the inner diameter of the stirred tank, for example, 0.005, 0.010, 0.015, 0.020, or 0.025 times. However, the multiple is not limited to the listed values; other unlisted values within this range are also applicable.

In some embodiments, the diameter of the first nested mixing impeller is 0.60 to 0.75 times the inner diameter of the stirred tank, for example, 0.60, 0.63, 0.66, 0.69, 0.72, or 0.75 times. However, the multiple is not limited to the listed values; other unlisted values within this range are also applicable.

The width of a helical blade is 0.05 to 0.12 times the inner diameter of the stirred tank, for example, 0.05, 0.06, 0.07, 0.08, 0.09, 0.10, 0.11, or 0.12 times. However, the multiple is not limited to the listed values; other unlisted values within this range are also applicable.

The height of the helical blade is 0.10 to 0.75 times the inner diameter of the stirred tank, for example, 0.10, 0.20, 0.30, 0.40, 0.50, 0.60, 0.70, or 0.75 times. However, the multiple is not limited to the listed values; other unlisted values within this range are also applicable.

The pitch of the helical blade is 0.5 to 4.0 times the inner diameter of the stirred tank, for example, 0.5, 1.0, 1.5, 2.0, 2.5, 3.0, 3.5, or 4.0 times. However, the multiple is not limited to the listed values; other unlisted values within this range are also applicable.

The spread angle of the helical blade is 30° to 120°, for example, 30°, 50°, 70°, 90°, 100°, or 120°. However, the degree is not limited to the listed values; other unlisted values within this range are also applicable.

In some embodiments, the diameter of a fixed shaft is 0.01 to 0.05 times the inner diameter of the stirred tank, for example, 0.01, 0.02, 0.03, 0.04, or 0.05 times. However, the multiple is not limited to the listed values; other unlisted values within this range are also applicable.

The fixed shaft is provided with multiple second protrusions. In the present disclosure, the fixed shaft is provided with multiple second protrusions so that the shear edge length of the impeller can be further increased, and the shear force on the slurry during mixing can be increased, thereby further improving the mixing effect.

The shape of the second protrusions includes a cylinder.

The diameter of a second protrusion is ½ to ⅔ of the diameter of the fixed shaft, for example, ½, 13/24, 7/12, ⅝, or ⅔. However, the multiple is not limited to the listed values; other unlisted values within this range are also applicable.

The height of the second protrusion is 2 to 3 times the diameter of the second protrusion, for example, 2.0, 2.2, 2.4, 2.6, 2.8, or 3.0 times. However, the multiple is not limited to the listed values; other unlisted values within this range are also applicable.

The multiple second protrusions are arranged in a staggered manner on the upper and lower sides of the fixed shaft.

The spacing between adjacent second protrusions on the same side of the fixed shaft is 2 to 5 times the diameter of the second protrusion, for example, 2, 3, 4, or 5 times. However, the multiple is not limited to the listed values; other unlisted values within this range are also applicable.

In some embodiments, the diameter of the second nested mixing impeller is 0.4 to 0.6 times the inner diameter of the stirred tank, for example, 0.40, 0.45, 0.50, 0.55, or 0.60 times. However, the multiple is not limited to the listed values; other unlisted values within this range are also applicable.

The second nested mixing impeller includes at least two bayonet-type blades.

The angle between a bayonet-type blade and the horizontal plane of the rotation direction is 30° to 60°, for example, 30°, 35°, 40°, 45°, 50°, 55°, or 60°. However, the degree is not limited to the listed values; other unlisted values within this range are also applicable.

The width of the bayonet-type blade is 0.15 to 0.35 times the diameter of the second nested mixing impeller, for example, 0.15, 0.20, 0.25, 0.30, or 0.35 times. However, the multiple is not limited to the listed values; other unlisted values within this range are also applicable.

In some embodiments, the leading surface of a bayonet-type blade is provided with multiple third protrusions.

In the present disclosure, the leading surface of a bayonet-type blade is provided with multiple third protrusions so that the shear edge length of the impeller can be further increased, the shear force on the slurry as it flows past the bayonet-type blade can be increased, thereby improving mixing efficiency.

The shape of the third protrusions includes a triangular prism.

The height of a third protrusion is 0.01 to 0.05 times the diameter of the second nested mixing impeller, for example, 0.01, 0.02, 0.03, 0.04, or 0.05 times. However, the multiple is not limited to the listed values; other unlisted values within this range are also applicable.

The width of the third protrusion is 0.01 to 0.05 times the diameter of the second nested mixing impeller, for example, 0.01, 0.02, 0.03, 0.04, or 0.05 times. However, the multiple is not limited to the listed values; other unlisted values within this range are also applicable.

In a second aspect, the present disclosure also provides an application of the combined impeller stirring device as described in the first aspect in the field of petrochemicals.

In some embodiments, the application includes an application in the gelation process of an FCC catalyst.

In the present disclosure, through the synergistic cooperation of the first nested mixing impeller and the second nested mixing impeller, the shear edge length of the impellers is increased, and the shear rate is increased, thereby shortening the macroscopic mixing time and acidification time of the slurry within the stirring device. Moreover, power consumption of mixing is reduced, and mixing efficiency is effectively improved. The application is particularly suitable for the acidification and gelation process of high-solid-content FCC catalyst slurry.

### BRIEF DESCRIPTION OF DRAWINGS

FIG. 1 is a view illustrating the structure of a combined impeller stirring device in embodiment one.

FIG. 2 is a diagram of a single mixing impeller unit in embodiment one.

FIG. 3 is a diagram illustrating the relative positions of two adjacent mixing impeller units in embodiment one.

FIG. 4 is a front view of a first nested mixing impeller in embodiment one.

FIG. 5 is a top view of a first nested mixing impeller in embodiment one.

FIG. 6 is a partial view of a triangular prism protrusion on a helical blade in embodiment one.

FIG. 7 is a front view of a bayonet-type blade in embodiment one.

FIG. 8 is a view illustrating the structure of a bayonet-type blade in embodiment one.

### REFERENCE LIST

1 stirred tank
2 stirring shaft
3 helical blade
4 fixed shaft
5 bayonet-type blade
6 baffle
7 first protrusion
8 second protrusion
9 third protrusion
a height of a mixing impeller unit
b spacing between two adjacent mixing impeller units
c height of a helical blade
d height of a second protrusion
e distance between adjacent second protrusions
f diameter of a first nested mixing impeller
g width of a helical blade
h spread angle of a helical blade
i height of a first protrusion
j width of a first protrusion
k diameter of a second nested mixing impeller
l width of a bayonet-type blade
m width of a third protrusion
n height of a third protrusion

### DETAILED DESCRIPTION

Technical solutions of the present disclosure are further described below through embodiments. It is to be understood by those skilled in the art that the embodiments described herein are used for a better understanding of the present disclosure and are not to be construed as specific limitations to the present disclosure.

Unless otherwise defined, all technical and scientific terms used herein have the same meanings as commonly understood by those skilled in the technical field of the present disclosure. The terms used herein are only used for describing specific embodiments and not intended to limit the present disclosure. The terms “including” and “having” in the specification, claims, and the preceding description of the drawings, as well as any variations thereof, are intended to cover a non-exclusive inclusion.

### Embodiment One

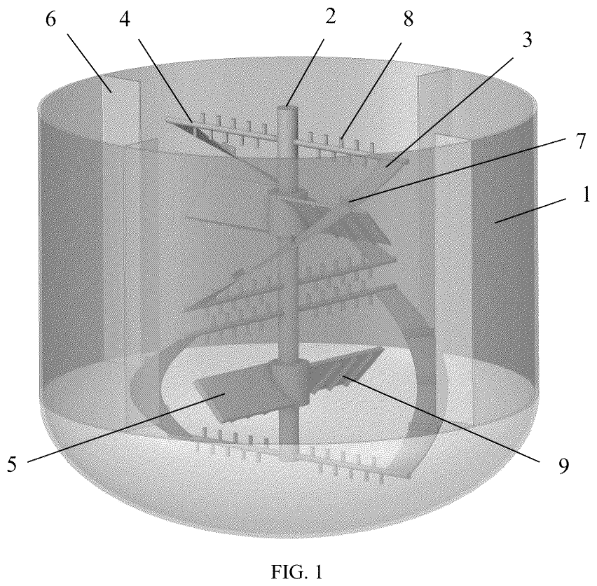

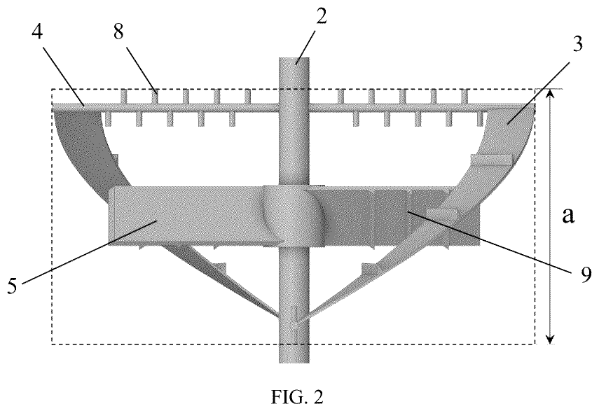

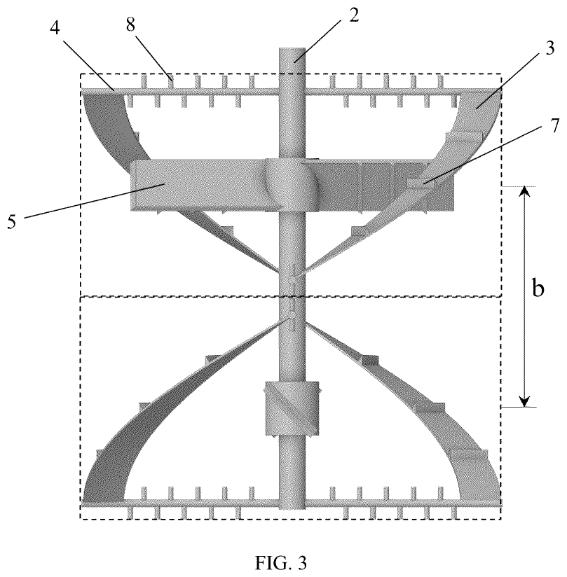

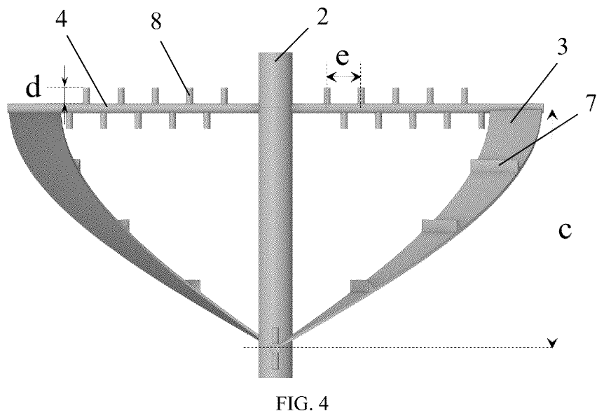

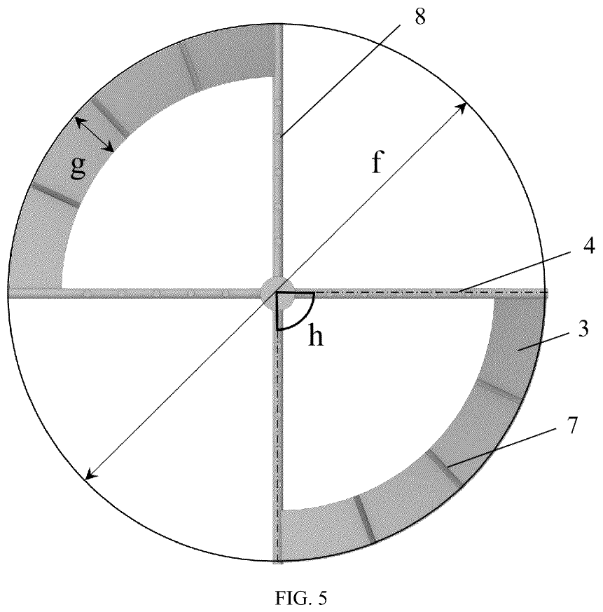

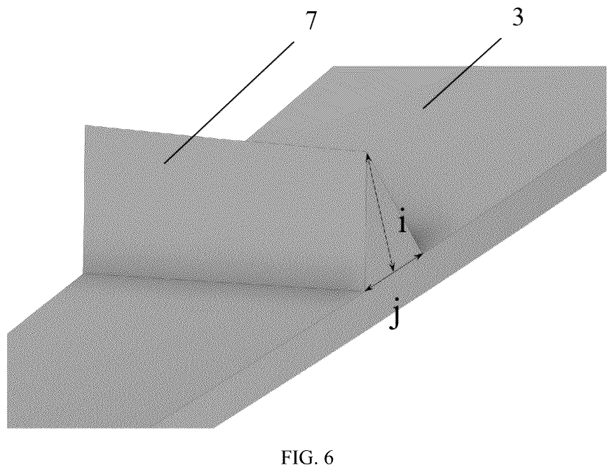

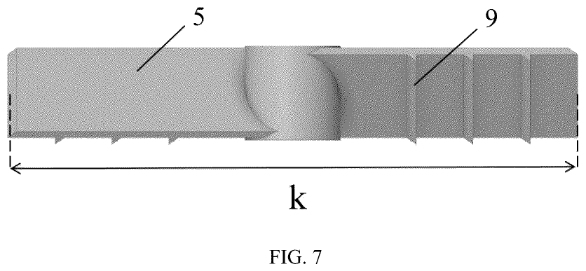

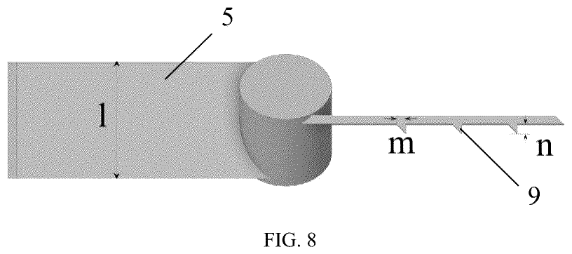

This embodiment provides a combined impeller stirring device, as shown in FIG. 1 to FIG. 8. The device includes a stirred tank 1, a stirring shaft 2, four baffles 6, a first nested mixing impeller, and a second nested mixing impeller. The four baffles 6 are arranged at equal intervals in the circumferential direction. The first nested mixing impeller is formed by two rotationally symmetric helical blades 3 and two fixed shafts 4. The fixed shafts 4 are fixed to the stirring shaft and arranged in a vertically staggered manner. The second nested mixing impeller is formed by two bayonet-type blades 5 fixed to an annular structure on the stirring shaft 2. The first nested mixing impeller and the second nested mixing impeller together form a mixing impeller unit. This embodiment includes two mixing impeller units staggered by 90°. Moreover, in this embodiment, the leading surface of each helical blade is provided with three triangular prism-shaped first protrusions arranged at equal intervals, each fixed shaft is provided with five cylindrical second protrusions arranged at equal intervals on the upper and lower sides of the fixed shaft, and the leading surface of each bayonet-type blade is provided with three triangular prism-shaped third protrusions arranged at equal intervals.

Specifically, the inner diameter of the stirred tank is 1.2 m, the height of the elliptical bottom head is 300 mm, and the liquid level height is 1.2 m. The height of each mixing impeller unit is 350 mm, and the spacing between two mixing impeller units is 400 mm. The width of a baffle is 120 mm. The diameter of the first nested mixing impeller is 800 mm, the width of a helical blade is 75 mm, the height of the helical blade is 230 mm, the spread angle is 90°, and the pitch is 1400 mm. The height of a first protrusion is 20 mm, and the width of the first protrusion is 20 mm. The diameter of a fixed shaft is 30 mm, the diameter of a second protrusion is 18 mm, the height is 45 mm, and the spacing between adjacent second protrusions is 140 mm. The diameter of the second nested mixing impeller is 600 mm, the inclination angle is 45°, the width of each bayonet-type blade is 125 mm, and the width and height of each third protrusion are 20 mm.

### Embodiment Two

This embodiment provides a combined impeller stirring device. The device includes a stirred tank, a stirring shaft, three baffles, a first nested mixing impeller, and a second nested mixing impeller. The three baffles are arranged at equal intervals in the circumferential direction. The first nested mixing impeller is formed by two rotationally symmetric helical blades and two fixed shafts. The fixed shafts are fixed to the stirring shaft and arranged in a vertically staggered manner. The second nested mixing impeller is formed by three bayonet-type blades fixed to an annular structure on the stirring shaft. The first nested mixing impeller and the second nested mixing impeller together form a mixing impeller unit. This embodiment includes one mixing impeller unit. Moreover, in this embodiment, the leading surface of each helical blade is provided with two triangular prism-shaped first protrusions arranged at equal intervals, each fixed shaft is provided with three cylindrical second protrusions arranged at equal intervals on the upper and lower sides of the fixed shaft, and the leading surface of each bayonet-type blade is provided with two triangular prism-shaped third protrusions arranged at equal intervals.

Specifically, the inner diameter of the stirred tank is 1.2 m, the height of the elliptical bottom head is 300 mm, and the liquid level height is 1.2 m. The height of the mixing impeller unit is 960 mm. The width of a baffle is 120 mm. The diameter of the first nested mixing impeller is 720 mm, the width of a helical blade is 60 mm, the height of the helical blade is 880 mm, the spread angle is 90°, and the pitch is 3600 mm. The height of a first protrusion is 6 mm, and the width of the first protrusion is 6 mm. The diameter of a fixed shaft is 20 mm, the diameter of a second protrusion is 10 mm, the height is 30 mm, and the spacing between adjacent second protrusions is 50 mm. The diameter of the second nested mixing impeller is 480 mm, the inclination angle is 30°, the width of each bayonet-type blade is 150 mm, and the width and height of each third protrusion are 5 mm.

### Embodiment Three

This embodiment provides a combined impeller stirring device. The device includes a stirred tank, a stirring shaft, two baffles, a first nested mixing impeller, and a second nested mixing impeller. The two baffles are arranged at equal intervals in the circumferential direction. The first nested mixing impeller is formed by two rotationally symmetric helical blades and two fixed shafts. The fixed shafts are fixed to the stirring shaft and arranged in a staggered manner. The second nested mixing impeller is formed by four bayonet-type blades fixed to an annular structure on the stirring shaft. The first nested mixing impeller and the second nested mixing impeller together form a mixing impeller unit. This embodiment includes three mixing impeller units staggered by 90°. Moreover, in this embodiment, the leading surface of each helical blade is provided with six triangular prism-shaped first protrusions arranged at equal intervals, each fixed shaft is provided with five cylindrical second protrusions arranged at equal intervals on the upper and lower sides of the fixed shaft, and the leading surface of each bayonet-type blade is provided with five triangular prism-shaped third protrusions arranged at equal intervals.

Specifically, the inner diameter of the stirred tank is 1.2 m, the height of the elliptical bottom head is 300 mm, and the liquid level height is 1.2 m. The height of each mixing impeller unit is 300 mm, and the spacing between two mixing impeller units is 330 mm. The width of a baffle is 120 mm. The diameter of the first nested mixing impeller is 900 mm, the width of a helical blade is 144 mm, the height of the helical blade is 124 mm, the spread angle is 120°, and the pitch is 600 mm. The height of a first protrusion is 30 mm, and the width of the first protrusion is 30 mm. The diameter of a fixed shaft is 48 mm, the diameter of a second protrusion is 32 mm, the height is 64 mm, and the spacing between adjacent second protrusions is 80 mm. The diameter of the second nested mixing impeller is 720 mm, the inclination angle is 60°, the width of each bayonet-type blade is 252 mm, and the width and height of each third protrusion are 36 mm.

### Embodiment Four

This embodiment provides a stirring device, which differs from embodiment one in that no baffles are provided, while the remaining structure is the same as in embodiment one.

### Embodiment Five

This embodiment provides a combined impeller stirring device, which differs from embodiment one in that no first protrusions are disposed on the helical blades, while the remaining structure is the same as in embodiment one.

### Embodiment Six

This embodiment provides a combined impeller stirring device, which differs from embodiment one in that no second protrusions are provided on the fixed shafts, while the remaining structure is the same as in embodiment one.

### Embodiment Seven

This embodiment provides a combined impeller stirring device, which differs from embodiment one in that no third protrusions are provided on the bayonet-type blades, while the remaining structure is the same as in embodiment one.

### Embodiment Eight

This embodiment provides a stirring device, which differs from embodiment one in that the spacing between two mixing impeller units is 500 mm, while the remaining structure is the same as in embodiment one.

### Embodiment Nine

This embodiment provides a combined impeller stirring device, which differs from embodiment one in that the height of the mixing impeller unit is 120 mm, and the remaining structure is the same as in embodiment one.

### Comparative Example 1

This comparative example provides a stirring device, which differs from embodiment one in that no first nested mixing impeller is provided, while the remaining structure is the same as in embodiment one.

### Comparative Example 2

This comparative example provides a stirring device, which differs from embodiment one in that no second nested mixing impeller is provided, while the remaining structure is the same as in embodiment one.

### Comparative Example 3

This comparative example provides a stirring device. The device includes a stirred tank, a stirring shaft, a double-layer downward-pumping inclined-blade combined impeller, and baffles. Specifically, the inner diameter of the stirred tank is 1.2 m, with an elliptical bottom head. The head height is 300 mm, and four baffles with a width of 120 mm are installed close to the inner wall. A double-layer downward-pumping inclined-blade combined impeller is installed on the stirring shaft. Each blade has a diameter of 600 mm, a width of 150 mm, two blades, and an inclination angle of 45°. The lower impeller is 350 mm from the bottom. The spacing between the two layers of impellers is 600 mm.

### Comparative Example 4

This comparative example provides a stirring device. The device includes a stirred tank, a stirring shaft, and a double ribbon impeller. Specifically, the inner diameter of the stirred tank is 1.2 m, with an elliptical bottom head. The head height is 300 mm. No baffles are disposed on the inner wall. A double ribbon impeller is installed on the stirring shaft, with a impeller diameter of 1080 mm, a impeller width of 150 mm, a impeller height of 900 mm, and a pitch of 600 mm.

### Application Example 1-1

This application example uses the stirring device from embodiment one. An FCC catalyst slurry with a solid content of 30% is added, and the mixing speed is set to 60 rpm for the mixing and gelation of the FCC catalyst.

### Application Example 1-2

This application example uses the stirring device from embodiment one. An FCC catalyst slurry with a solid content of 38% is added, and the mixing speed is set to 60 rpm for the mixing and gelation of the FCC catalyst.

### Application Examples 2-10

Application examples 2-10 use the stirring devices from embodiments two to ten, respectively. An FCC catalyst with a solid content of 38% is added, and the mixing speed is set to 60 rpm for the mixing and gelation of the FCC catalyst.

### Comparative Application Example 1

This comparative application example uses the stirring device from comparative example 1. An FCC catalyst with a solid content of 38% is added, and the mixing speed is set to 60 rpm for the mixing and gelation of the FCC catalyst.

### Comparative Application Example 2

This comparative application example uses the stirring device from comparative example 2. An FCC catalyst with a solid content of 38% is added, and the mixing speed is set to 60 rpm for the mixing and gelation of the FCC catalyst.

### Comparative Application Example 3-1

This comparative application example uses the stirring device from comparative example 3. An FCC catalyst slurry with a solid content of 30% is added, and the mixing speed is set to 60 rpm for the mixing and gelation of the FCC catalyst.

### Comparative Application Example 3-2

This comparative application example uses the stirring device from comparative example 3. An FCC catalyst with a solid content of 38% is added, and the mixing speed is set to 60 rpm for the mixing and gelation of the FCC catalyst.

### Comparative Application Example 4-1

This comparative application example uses the stirring device from comparative example 4. An FCC catalyst slurry with a solid content of 30% is added, and the mixing speed is set to 60 rpm for the mixing and gelation of the FCC catalyst.

### Comparative Application Example 4-2

This comparative application example uses the stirring device from comparative example 4. An FCC catalyst with a solid content of 38% is added, and the mixing speed is set to 60 rpm for the mixing and gelation of the FCC catalyst.

### Performance Testing

The power consumption and mixing time of application examples 1-9 and comparative application examples 1-4 are tested using the shaft torque method. The test results are described in table 1 below.

TABLE 1

| | Power | Macro Mixing |
|---|---|---|
| | consumption P | Time t |
| | (kW) | (s) |
| Application Example 1-1 | 24.5 | 12.5 |
| Application Example 1-2 | 32.4 | 15.6 |
| Application Example 2 | 25.1 | 18.7 |
| Application Example 3 | 33.5 | 14.9 |
| Application Example 4 | 25.3 | 20.1 |
| Application Example 5 | 34.0 | 17.9 |
| Application Example 6 | 33.2 | 17.5 |
| Application Example 7 | 35.6 | 18.3 |
| Application Example 8 | 37.3 | 20.3 |
| Application Example 9 | 30.0 | 21.1 |
| Comparative Application Example 1 | 40.2 | 39.9 |
| Comparative Application Example 2 | 45.5 | 52.1 |
| Comparative Application Example 3-1 | 35.7 | 28.2 |
| Comparative Application Example 3-2 | 47.5 | 48.5 |
| Comparative Application Example 4-1 | 42.3 | 16.4 |
| Comparative Application Example 4-2 | 59.6 | 36.1 |

From the data of application examples 1-3 in table 1, it can be seen that in the combined stirring device provided by the present disclosure, the number of mixing impeller units can be adjusted based on actual needs. Through the synergistic cooperation of the first nested mixing impeller and the second nested mixing impeller, the mixing effect of high-viscosity and variable-viscosity fluids in the reactor can be effectively improved, and the mixing time can be significantly reduced.

From the data of the application example 1-2 and comparative application examples 1 and 2 in table 1, when the FCC slurry with 38% solid content is processed, the combined impeller stirring device provided by embodiment one reduces power consumption by 19.4% and 28.8%, respectively, and macroscopic mixing time by 60.9% and 70.0%, respectively, compared to the stirring devices provided by comparative examples 1 and 2. This demonstrates that in the present disclosure, the cooperation of the first and second nested mixing impellers significantly increases mixing efficiency.

From the data of the application example 1 and comparative application examples 3 and 4 in table 1, when the FCC slurry with 38% solid content is processed, the combined impeller stirring device provided by embodiment one reduces power consumption by 31.4% and 42.1%, respectively, and macroscopic mixing time by 55.7% and 23.8%, respectively, compared to the stirring devices provided by comparative examples 3 and 4; when the FCC slurry with 38% solid content is processed, the combined impeller stirring device provided by embodiment one reduces power consumption by 31.8% and 45.6%, respectively, and macroscopic mixing time by 67.8% and 37.5%, respectively, compared to the stirring devices provided by comparative examples 1 and 2. This demonstrates that the combined impeller stirring device provided by the present disclosure, compared to existing double-layer downward-pumping inclined-blade combined impellers and double ribbon impellers, offers higher mixing efficiency and can effectively reduce power consumption of mixing, shorten mixing time, and maintain good mixing performance when high-solid-content slurry is mixed.

From the data of the application example 1-2 and application example 4 in table 1, when the FCC slurry with 38% solid content is processed, the combined impeller stirring device provided by embodiment one, compared to the stirring device provided by embodiment four, has slightly higher power consumption but reduces mixing time by 22.4%. This demonstrates that in the present disclosure, the provision of baffles can further increase mixing efficiency.

From the data of the application example 1-2 and application examples 5-7 in table 1, when the FCC slurry with 38% solid content is processed, the combined impeller stirring device provided by embodiment one reduces power consumption by 4.7%, 2.4%, and 9.0%, respectively, and mixing time by 12.8%, 10.9%, and 14.8%, respectively, compared to the stirring devices provided by embodiments 5-7. This demonstrates that in the present disclosure, the provision of multiple protrusions on the helical blades, fixed shafts, and bayonet-type blades can further improve the mixing efficiency of the slurry and reduce energy consumption.

From the data of the application example 1-2 and application examples 8 and 9 in table 1, when the FCC slurry with 38% solid content is processed, the combined impeller stirring device provided by embodiment one reduces mixing time by 23.2% and 26.1%, respectively, compared to the stirring devices provided by embodiments eight and nine. This demonstrates that in the present disclosure, adjusting and controlling the height and spacing of the mixing impeller units can further reduce the time required for slurry mixing and increase mixing efficiency.

What is claimed is:

1. A combined impeller stirring device, comprising a stirred tank, a stirring shaft disposed within the stirred tank, and at least two mixing impeller units disposed on the stirring shaft, wherein each mixing impeller unit of the at least two mixing impeller units comprises a first nested mixing impeller and a second nested mixing impeller; wherein
the first nested mixing impeller comprises two helical blades and two fixed shafts, the two fixed shafts are arranged in a staggered manner and are fixedly connected to the stirring shaft, two ends of each helical blade of the two helical blades are respectively connected to the two fixed shafts such that the two helical blades are arranged in rotational symmetry, the second nested mixing impeller is located between the two fixed shafts and is fixedly connected to the stirring shaft, each fixed shaft of the two fixed shafts is provided with a plurality of second protrusions, and the plurality of second protrusions are arranged in a staggered manner on upper and lower sides of the each fixed shaft;
the second nested mixing impeller comprises at least two bayonet-type blades;
the at least two mixing impeller units are arranged at intervals in an axial direction of the stirring shaft, adjacent mixing impeller units of the at least two mixing impeller units are staggered by 90°, a height of the each mixing impeller unit is 0.25 to 0.80 times an inner diameter of the stirred tank, and a spacing between the adjacent mixing impeller units is 1.00 to 1.25 times the height of the each mixing impeller unit;
a diameter of the first nested mixing impeller is 0.60 to 0.75 times the inner diameter of the stirred tank; and
a plurality of baffles are uniformly distributed on an inner wall of the stirred tank and are arranged parallel to the stirring shaft.

2. The combined impeller stirring device according to claim 1, wherein the plurality of baffles are arranged at equal intervals in a circumferential direction of the stirred tank.

3. The combined impeller stirring device according to claim 1, wherein a leading surface of each helical blade of the two helical blades is provided with the plurality of first protrusions;
the plurality of first protrusions are arranged at equal intervals in a length direction of the each helical blade;
a shape of each first protrusion of the plurality of first protrusions comprises a triangular prism;
a height of the each first protrusion is 0.005 to 0.025 times the inner diameter of the stirred tank; and
a width of the each first protrusion is 0.005 to 0.025 times the inner diameter of the stirred tank.

4. The combined impeller stirring device according to claim 1, wherein a width of each helical blade of the two helical blades is 0.05 to 0.12 times the inner diameter of the stirred tank;
a height of the each helical blade is 0.10 to 0.75 times the inner diameter of the stirred tank;
a pitch of the each helical blade is 0.5 to 4.0 times the inner diameter of the stirred tank; and
a spread angle of the each helical blade is 300 to 120°.

5. The combined impeller stirring device according to claim 1, wherein a diameter of the each fixed shaft is 0.01 to 0.05 times the inner diameter of the stirred tank;
a shape of each second protrusion of the plurality of second protrusions comprises a cylinder;
a diameter of the each second protrusion of the plurality of second protrusions is ½ to ⅔ of a diameter of the each fixed shaft;
a height of the each second protrusion is 2 to 3 times the diameter of the each second protrusion; and
a spacing between adjacent second protrusions of the plurality of second protrusions on a same side of the each fixed shaft is 2 to 5 times the diameter of the each second protrusion.

6. The combined impeller stirring device according to claim 1, wherein a diameter of the second nested mixing impeller is 0.4 to 0.6 times the inner diameter of the stirred tank;
an angle between each bayonet-type blade of the at least two bayonet-type blades and a horizontal plane is 30° to 60°; and
a width of the each bayonet-type blade is 0.15 to 0.35 times the diameter of the second nested mixing impeller.

7. The combined impeller stirring device according to claim 1, wherein a leading surface of each bayonet-type blade of the at least two bayonet-type blades is provided with a plurality of third protrusions;
a shape of each third protrusion of the plurality of third protrusions comprises a triangular prism;
a height of the each third protrusion of the plurality of third protrusions is 0.01 to 0.05 times a diameter of the second nested mixing impeller; and
a width of the third protrusion is 0.01 to 0.05 times the diameter of the second nested mixing impeller.

8. A method for applying a combined impeller stirring device, wherein the combined impeller stirring device comprises a stirred tank, a stirring shaft disposed within the stirred tank, and at least two mixing impeller units disposed on the stirring shaft, wherein each mixing impeller unit of the at least two mixing impeller units comprises a first nested mixing impeller and a second nested mixing impeller; wherein
the first nested mixing impeller comprises two helical blades and two fixed shafts, the two fixed shafts are arranged in a staggered manner and are fixedly connected to the stirring shaft, two ends of each helical blade of the two helical blades are respectively connected to the two fixed shafts such that the two helical blades are arranged in rotational symmetry, the second nested mixing impeller is located between the two fixed shafts and is fixedly connected to the stirring shaft, each fixed shaft of the two fixed shafts is provided with a plurality of second protrusions, and the plurality of second protrusions are arranged in a staggered manner on upper and lower sides of the each fixed shaft;
the second nested mixing impeller comprises at least two bayonet-type blades;
the at least two mixing impeller units are arranged at intervals in an axial direction of the stirring shaft, adjacent mixing impeller units of the at least two mixing impeller units are staggered by 90°, a height of the each mixing impeller unit is 0.25 to 0.80 times an inner diameter of the stirred tank, and a spacing between the adjacent mixing impeller units is 1.00 to 1.25 times the height of the each mixing impeller unit;
a diameter of the first nested mixing impeller is 0.60 to 0.75 times the inner diameter of the stirred tank; and
a plurality of baffles are uniformly distributed on an inner wall of the stirred tank and are arranged parallel to the stirring shaft;
the method comprises:
applying the combined impeller stirring device in a field of petrochemicals.

9. The method for applying a combined impeller stirring device according to claim 8, wherein applying the combined impeller stirring device in a field of petrochemicals comprises:
applying the combined impeller stirring device in a gelation process of an FCC catalyst.

10. The method for applying a combined impeller stirring device according to claim 8, wherein the plurality of baffles are arranged at equal intervals in a circumferential direction of the stirred tank.

11. The method for applying a combined impeller stirring device according to claim 8, wherein a leading surface of each helical blade of the two helical blades is provided with the plurality of first protrusions;
the plurality of first protrusions are arranged at equal intervals in a length direction of the each helical blade;
a shape of each first protrusion of the plurality of first protrusions comprises a triangular prism;
a height of the each first protrusion is 0.005 to 0.025 times the inner diameter of the stirred tank; and
a width of the each first protrusion is 0.005 to 0.025 times the inner diameter of the stirred tank.

12. The method for applying a combined impeller stirring device according to claim 8, wherein a width of each helical blade of the two helical blades is 0.05 to 0.12 times the inner diameter of the stirred tank;
a height of the each helical blade is 0.10 to 0.75 times the inner diameter of the stirred tank;
a pitch of the each helical blade is 0.5 to 4.0 times the inner diameter of the stirred tank; and
a spread angle of the each helical blade is 300 to 120°.

13. The method for applying a combined impeller stirring device according to claim 8, wherein a diameter of the each fixed shaft is 0.01 to 0.05 times the inner diameter of the stirred tank;
a shape of each second protrusion of the plurality of second protrusions comprises a cylinder;
a diameter of the each second protrusion of the plurality of second protrusions is ½ to ⅔ of a diameter of the each fixed shaft;
a height of the each second protrusion is 2 to 3 times the diameter of the each second protrusion; and
a spacing between adjacent second protrusions of the plurality of second protrusions on a same side of the each fixed shaft is 2 to 5 times the diameter of the each second protrusion.

14. The method for applying a combined impeller stirring device according to claim 8, wherein a diameter of the second nested mixing impeller is 0.4 to 0.6 times the inner diameter of the stirred tank;
an angle between each bayonet-type blade of the at least two bayonet-type blades and a horizontal plane is 30° to 60°; and
a width of the each bayonet-type blade is 0.15 to 0.35 times the diameter of the second nested mixing impeller.

15. The method for applying a combined impeller stirring device according to claim 8, wherein a leading surface of each bayonet-type blade of the at least two bayonet-type blades is provided with a plurality of third protrusions;
a shape of each third protrusion of the plurality of third protrusions comprises a triangular prism;
a height of the each third protrusion of the plurality of third protrusions is 0.01 to 0.05 times a diameter of the second nested mixing impeller; and
a width of the third protrusion is 0.01 to 0.05 times the diameter of the second nested mixing impeller.
